(19) United States
(12) Patent Application Publication
(10) Pub. No.: US 2008/0049213 A1
(43) Pub. Date: Feb. 28, 2008

(54) Particle diameters measuring method and device

(75) Inventor: Yukihisa Wada, Kyoto-shi (JP)

Correspondence Address: RADER FISHMAN & GRAUER PLLC, LION BUILDING, 1233 20TH STREET N.W., SUITE 501, WASHINGTON, DC, 20036, US

(73) Assignee: SHIMADZU CORPORATION, Kyoto (JP)

(21) Appl. No.: 11/785,803

(22) Filed: Apr. 20, 2007

(30) Foreign Application Priority Data
Aug. 23, 2006 (JP) 2006-227207

(51) Int. Cl. G01N 1/00

(52) U.S. Cl. 356/36; 977/840

(57) ABSTRACT

The invention provides particle diameters measuring method and device capable of preventing noise from occurring due to an error in the formation of electrodes, capable of obtaining a high S/N ratio and the diffusion coefficients of the particles to be measured, and capable of exactly measuring the particle diameters of minute particles, such as nanoparticles. A particle diameters measuring method includes: forming a concentration gradient of a particles to be measured by impressing an electric field upon a sample in which the particles are movably dispersed within a medium through an electrode pair 2 provided to be in contact with or close to the sample; detecting a refractive index at a portion where the concentration gradient is formed by introducing a light beam Ls to a portion where the concentration gradient is formed and which is apart from the electrode pair 2 by a predetermined distance; obtaining a diffusion coefficients of the particles to be measured within the medium from a temporal variation in the refractive index after the impression of the electric field upon the particles stops or changes; and calculating the particle diameters of particles to be measured by applying the diffusion coefficients to Einstein-Stokes equation.

### BACKGROUND OF THE INVENTION

1. Field of the Invention

The present invention relates to a particle diameters measuring method and device, and more particularly, to a particle diameters measuring method and device suitable for measuring the diameters of nanoparticles whose diameters are equal to or less than 100 nm.

2. Description of the Related Art

In the past, a measuring method referred to as a dynamic scattering method (photon correlation method) was frequently used as a method of measuring the particle diameters of minute particles including nanoparticles. The dynamic scattering method is a method of catching a fluctuation in the intensity of a scattered light beam which is caused by Brownian motion of the particles, that is, a temporal variation in a scattered light beam, and calculating the size modulation of the particles to be measured by using a fact that each particles undergo Brownian motion with an intensity based on their diameters.

In the dynamic scattering method (particle correlation method) of measuring a fluctuation of a light beam scattered by particles, it is necessary to measure a small fluctuation of a large scattered light beam, that is, to measure a variation of the light intensity in bright field of view. Therefore, in the principle of the dynamic scattering method, the measurement sensitivity is low and an S/N ratio is bad.

In order to solve those problems, this applicant has already proposed a method of generating a diffraction grating based on the density modulation of particles to be measured by impressing a space-periodical electric field upon the particles to be measured dispersed within a medium, obtaining a diffracted light beam by irradiating a light beam onto the diffraction grating, and obtaining the particle diameters of particles to be measured from a temporal variation in the diffracted light beam during the course of extinguishing of the diffraction grating (see Japanese Patent Laid-Open Publication No. 2006-84207).

That is, in the proposed method, a space-periodical electric field is impressed upon the particles to be measured movably dispersed within the medium. The particles to be measured undergoes phoresis by the application of the electric field such that a density modulation based on the space period of the electric field is generated, and a diffraction grating based on the density modulation of the particles to be measured, that is, a density diffraction grating is generated. The state of the diffractive grating can be grasped by detecting a diffracted light beam obtained by irradiating a light beam onto the diffractive grating. When the application of the electric field stops or changes in the state when the density diffraction grating has been generated, the particles start diffusion such that extinguishing the density diffraction grating disappears. The extinguishing speed depends on the diffusion speed of the particles to be measured. Therefore, it is possible to see the diffusion speed of the particles to be measured by measuring a temporal variation in the diffracted light beam during the course of the extinguishing of the density diffraction grating, and to obtain the diameters of particles from the diffusion speed by using Einstein-Stokes equation.

By using the proposed method, it is possible to obtain the particle diameters of minute particles with high sensitivity and a high S/N ratio, as compared to the dynamic scattering method.

Also, this applicant has proposed an instrument for measuring the diffusivity of the particles. In the instrument, when a high-frequency voltage is impressed upon electrodes formed on a wall surface of a chamber containing a sample in which the particles are movably dispersed within a medium, an area having a high electric force line density and an area having a low electric force line density are formed and the particles undergo phoresis to generate the particles concentrating area and the particles dilute area. Then, the refractive index of the particles dilute or concentrating area is detected through sensor surfaces supplied on the same wall surface as the electrodes. When the impression of the voltage upon the electrodes stops or changes, the particles start diffusion. The diffusivity of particles is measured from a temporal variation in the refractive index from a time point when the particles start diffusion (see Japanese Patent Laid-Open Publication No. 2006-29781).

Of the above-mentioned proposals, in the former technique using the behavior of the particles during the course of extinguishing of a density diffraction grating generated by the particles to be measured, when the concentration of the particles to be measured becomes high so as to form the density diffraction grating, the density of the particles immediately after diffusion start is excessively high. Therefore, the Einstein-Stokes equation may not be satisfied.

Also, when a dimension error of the period of the electrode pair for forming an electric field in the sample is large, an error occurs even in the period of the density diffraction grating and thus a large amount of noise may be in the diffracted light beam. For this reason, it is required to form the electrode pair with high accuracy.

In the latter instrument for measuring the diffusivity of the particles, it is not considered to obtain the diameters of particles. Even when the instrument is used to measure the diameters of particles, since the sensor surfaces for detecting the refractive index are provided on the same wall surface as the electrodes, as described above, in a case in which the concentration in the particles concentrating area immediately after the impression of the voltage stops or changes becomes high, the Einstein-Stokes equation may not be satisfied.

### SUMMARY OF THE INVENTION

The present invention is devised in view of the foregoing problems, and accordingly, it is an object of the present invention to provide a particle diameters measuring method and device allowing application of Einstein-Stokes equation to be possible from a time point when diffusion starts and thus capable of accurately measuring the diameters of the particles without being affected by an error in the formation of electrodes.

In order to attain the above-mentioned object, according to a first aspect of the present invention, there is provided a particle diameters measuring method which includes:

forming a concentration gradient of the particles to be measured by impressing an electric field upon a sample in which the particles to be measured are movably dispersed within a medium through an electrode pair provided to be in contact with or close to the sample; detecting a refractive index at a portion where the concentration gradient is formed by introducing a light beam to a portion where the concentration gradient is formed and which is apart from the electrode pair by a predetermined distance; obtaining a diffusion coefficients of the particles to be measured within the medium from a temporal variation in the refractive index after the impression of the electric field upon the particles to be measured stops or changes; and calculating the particle diameters of the particles to be measured by applying the diffusion coefficients to Einstein-Stokes equation.

Also, according to the particle diameters measuring device of the present invention(according to a second aspect), there is provided a particle diameters measuring device which includes: a container storing a sample in which a particles to be measured is movably dispersed within a medium; an electrode pair provided within the container to be in contact with or close to the sample; a electric power supply impressing a positive or negative voltage upon the electrode pair; a light source emitting a light beam to be introduced to a portion where a concentration gradient of the particles is formed by impressing the positive or negative voltage upon the electrode pair and which is apart from the electrode pair by a predetermined distance; a refractive index detecting unit detecting a refractive index of the sample by using the introduced light beam; and a calculating unit receiving an output of the refractive index detecting unit, obtaining a diffusion coefficients of the particles to be measured within the medium from a temporal variation in the refractive index after the impression of the voltage upon the electrode pair stops or changes, and calculating the particle diameters of the particles to be measured by using Einstein-Stokes equation.

According to the particle diameters measuring device of present invention, there may be preferable employed such a configuration (according to third aspect) that the refractive index detecting unit may be based on an optical heterodyning technique using a sample light beam introduce from the light source to the portion where the concentration gradient of the particles within the container and a reference light beam generated from the light source passing through a position where the reference light beam is not affected by the concentration gradient.

Further, the particle diameters measuring device of the present invention, there may be employed such a configuration (according to fourth aspect), that the light beam may be introduced at a parallel state into the portion where the concentration gradient of the particles to be measured within the container is formed. Alternatively, the present invention may employ such a configuration (according to fifth aspect), that the light beam from the light source may be introduced into the container through a condensing lens.

Also, the present invention may employ such a configuration (according to sixth aspect), that the light beam is introduced into the portion, where the concentration gradient is formed, through an optical fiber disposed within the container. Alternatively, the present invention may employ such a configuration (according to seventh aspect), that the light beam is introduced into the portion, where the concentration gradient is formed, through a total reflecting glass plate disposed within the container. Moreover, the present invention may employ such a configuration (according to eighth aspect), that the light beam is introduced into the portion, where the concentration gradient is formed, through an optical waveguide provided within the container.

In the particle diameters measuring device according to the second aspect which forms the concentration gradient of the particles by impressing the voltage upon the electrode pair provided within the container, there may be employed such a configuration (according to ninth aspect), that a plurality of electrode pairs may be formed within the container.

According to a tenth aspect of the present invention, there is provided a particle diameters measuring device that uses another method which forming a concentration gradient of particles to be measured within a medium. The particle diameters measuring device according to tenth aspect includes: a container containing a sample in which a particles to be measured are movably dispersed within a medium, or only the medium; a pump injecting, to the container, a high concentration sample in which a particles to be measured is movably dispersed at higher concentration within the medium; a light source emitting a light beam to be introduced to a portion where a concentration gradient of the particles is formed by injecting the high concentration sample; a refractive index detecting unit detecting a refractive index of the medium within which the particles to be measured is dispersed by using the introduced light beam; and a calculating unit receiving an output of the refractive index detecting unit, obtaining a diffusion coefficients of the particles to be measured within the medium from a temporal variation in the refractive index after the impression of the voltage upon the electrode pair stops or changes, and calculating the particle diameters of particles to be measured by using Einstein-Stokes equation.

The particle diameters measuring method and devices according to the first to ninth aspects of the present invention are based on the following principles.

That is, an electric field is impressed through the electrode pair upon the particles to be measured movably dispersed within the medium within the container such that the particles to be measured undergoes phoresis, thereby forming a concentration gradient of the particles to be measured within the medium. When the impression of the electric field stops or changes such that, the particles to be measured start diffusion, the concentration gradient finally extinguishes. The concentration gradient extinguishing process depends on the diffusion speed of the particles to be measured within the medium.

Meanwhile, the refractive index of the medium within which the particles is extinguished varies according to the concentration of the particles. Therefore, it is possible to obtain the diffusion coefficients of the particles to be measured by measuring the refractive index of the portion where the concentration gradient of the particles to be measured is formed, and measuring it during the extinguishing of the concentration gradient.

In the measuring method of refractive index according to the present invention, a light beam is introduced into a portion which is apart from the electrode pair formed within the container by a predetermined distance and where the concentration gradient is formed. Therefore, it is possible to measure the refractive index while avoiding an area where the density of the particles to be measured is high and Einstein-Stokes equation is not satisfied. Accordingly, it is possible to exactly calculate the diameters of the particles from the diffusion coefficients of the particles to be measured obtained as described above.

Similar to the case of using the density diffraction grating of the particle to be measured, an error in the formation of the electrodes does not affect the measurement result. Therefore, noise causing inconsistency of the period of the density diffraction grating may be prevented.

According to the first to ninth aspects of the present invention, the phoretic force acting on the particles may be a dielectrophoretic force or an electrophoretic force. When the particles undergo phoresis by the dielectrophorestic force, the voltage impressed upon the electrode pair is an AC voltage (high-frequency voltage) and thus an AC electric field is formed within the container. Also, when the particles to be measured are charged particles, an electrophoretic force may be used. In this case, a DC voltage is impressed upon the electrode pair and an electric field gradient is formed.

Meanwhile, in the particle diameters measuring device according to the tenth aspect of the present invention, in order to generate the concentration gradient of the particles to me measured within the medium, there is used a method different from those used in the particle diameters measuring method and device according to the first to ninth aspects of the present invention. More specifically, the high concentration sample in which the particles to be measured are dispersed at high concentration within the medium is injected, by means of the pump, into the container containing only the medium or the sample in which the particles to be measured are dispersed at low concentration within the medium, instead of impressing an electric field by using the electrode pair, thereby generating the concentration gradient. After the high concentration sample is introduced into the container, when the injection of the high concentration sample stops, finally, it extinguishes concentration gradient. When the refractive index measurement using a light beam as described above is used during the extinguishing process, it is possible to obtain substantially the same measurement result as in the above aspects of the present invention.

According to the present invention, there is no possibility that noise occurs due to an error in the formation of the electrodes, and it is possible to obtain an excellent S/N ratio and the diffusion coefficients of the particles to be measured and thus to exactly measure the particle diameters of minute particles, such as nanoparticles. In addition, since the measurement of the refractive index is performed while avoiding the area where the density of the particles to be measured is high, the Einstein-Stokes equation is satisfied from the time point when the diffusion starts and the particle diameters is exactly obtained.

### BRIEF DESCRIPTION OF THE DRAWINGS

FIG. 1 is a configuration diagram according to an embodiment of the present invention including both a schematic diagram showing an optical configuration and a block diagram showing a system configuration;

FIG. 2 is a perspective view illustrating the structure of a container 1 shown in FIG. 1;

FIGS. 3A to 3D are views for explaining the operation of the embodiment of the present invention, and more specifically, each are a view, partly in a schematic view illustrating the behavior of particles during a measurement operation and partly in a graph illustrating the modulation of the refractive index in a vertical direction;

FIGS. 4A to 4B are views for explaining refractive index detection based on an optical heterodyning technique in the embodiment of the present invention, more specifically, FIG. 4A showing the phase of a reference light beam and FIG. 4B showing the phase of a sample light beam;

FIG. 5 is a graph showing graphs for explaining the above-mentioned measurement operation in the embodiment of the present invention, more specifically, FIG. 5A showing the waveform of the voltage impressed upon the electrode pair, FIG. 5B showing a variation in the phase of the sample light beam, and FIG. 5C showing a variation of the refractive index of the sample;

FIG. 6 is a view illustrating an example in which a parallel light beam is guided into the container as the sample light beam according to the embodiment of the present invention;

FIG. 7 is a view illustrating an example in which the sample light beam is condensed by a lens so as to be guided into the container according to the embodiment of the present invention;

FIG. 8 is a view illustrating an example in which the sample light beam is guided into the container through an optical fiber according to the embodiment of the present invention;

FIG. 9 is a view illustrating an example in which the sample light beam is guided into the container by an optical element that transmits the light beam by total reflection according to the embodiment of the present invention;

FIG. 10 is a view illustrating an example in which the sample light beam is guided into the container through an optical waveguide according to the embodiment of the present invention;

FIG. 11 is a view illustrating another configuration of the electrode pair according to the embodiment of the present invention;

FIG. 12 is a view illustrating an example of a case when the reference light beam passes through the container according to the embodiment of the invention; and

FIG. 13 is a view illustrating an example in which a concentration gradient of the particles is formed within the container by using a pump according to another embodiment of the present invention.

### DETAILED DESCRIPTION OF THE PREFERRED EMBODIMENTS

Hereinafter, embodiments of the present invention will be described with reference to the accompanying drawings.

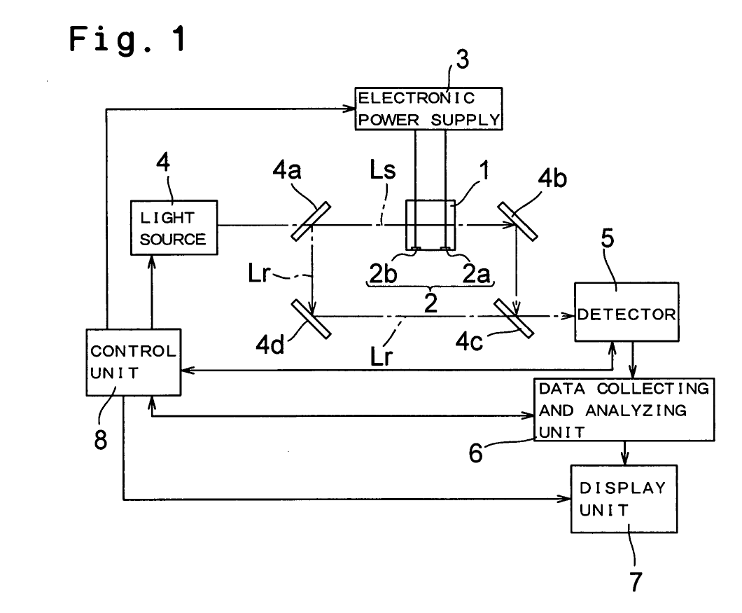

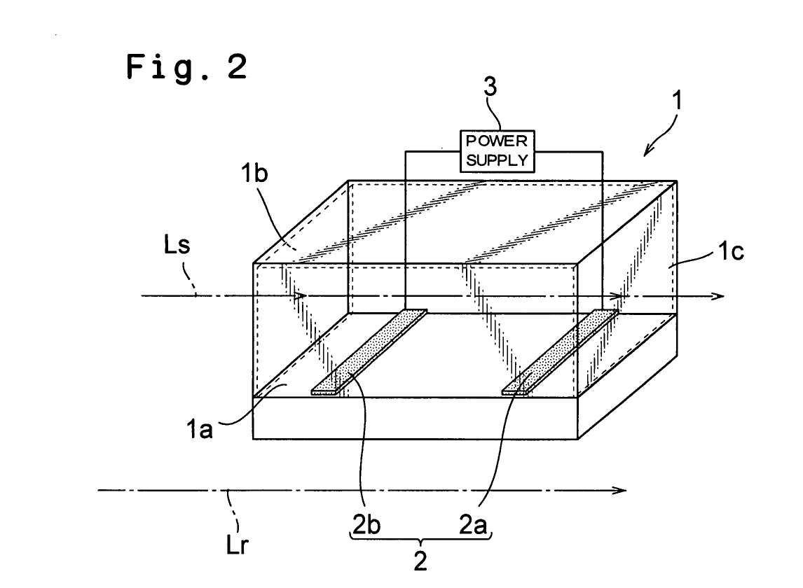

FIG. 1 is a configuration diagram according to an embodiment of the present invention including both a schematic diagram showing an optical configuration and a block diagram showing a system configuration. FIG. 2 is a perspective view illustrating the structure of a container 1 shown in FIG. 1.

In this embodiment, the container 1 is a rectangular parallelepiped and a sample in which the particles to be measured are movably dispersed within a medium is contained within the container 1. On the bottom surface la of the container 1, an electrode pair 2 made of two electrodes 2a and 2b is formed. An AC voltage (high-frequency voltage) from an electronic power supply 3 is impressed upon the electrode pair 2.

At least two side walls 1b and 1c, facing each other, of walls constituting the container 1 are formed of a transparent material, such as glass. A sample light beam Ls for refractive index measurement based on an optical heterodyning technique is guided into the container 1 from one side wall 1b of the transparent side walls 1b and 1c. The sample light beam Ls is guided into the container 1 so as to pass through the container 1 apart from the bottom surface 1a, where the electrode pair 2 is formed, of the container 1 by a predetermined distance, and moves toward the external through the other side wall 1c. Further, a reference light beam Lr is guided into the external of the container 1. Modulation light beams whose phases are consistent with each other are used as the sample light beam Ls and the reference light beam Lr.

That is, a light beam from a common light source 4 is split into two light beams by a half mirror 4a. One of the split light beams is guided into the container 1 as the sample light beam Ls and the other is guided to the external of the container 1 as the reference light beam Lr. The sample light beam Ls having passed through the container 1 is guided to a half mirror 4c by a mirror 4b and the reference light beam Lr also is guided to the half mirror 4c by a mirror 4d. In the half mirror 4c, the sample light beam Ls and the reference light beam Lr are superimposed. Then, the superimposed sample light beam Ls and reference light beam Lr enter a detector 5.

Although will be described below, a phase lead or lag according to the refractive index of the sample occurs in the sample light beam Ls, while the reference light beam Lr maintains the phase of when the reference light beam Lr was output from the light source 4. Therefore, a beat results from the superimpositioning of the two light beams. The detector 5 perceives the lead or lag of the phase of the sample light beam, and accordingly, a variation in the refractive index of the sample within the container 1, as the amount of change in a beat signal.

An output of the detector 5 is input to a data collecting and analyzing unit 6. The data collecting and analyzing unit 6 calculates the particle diameters of particles to be measured from the beat signal intercorrelating with the refractive index of the sample detected by the detector 5, which will be described below. The calculation result and so on is displayed on a display unit 7.

The electronic power supply 3, the light source 4, the detector 5, the data collecting and analyzing unit 6, and the display unit 7 all are under the control of a controller 8, and the controller 8 controls a sequence of measurement operation to be described below.

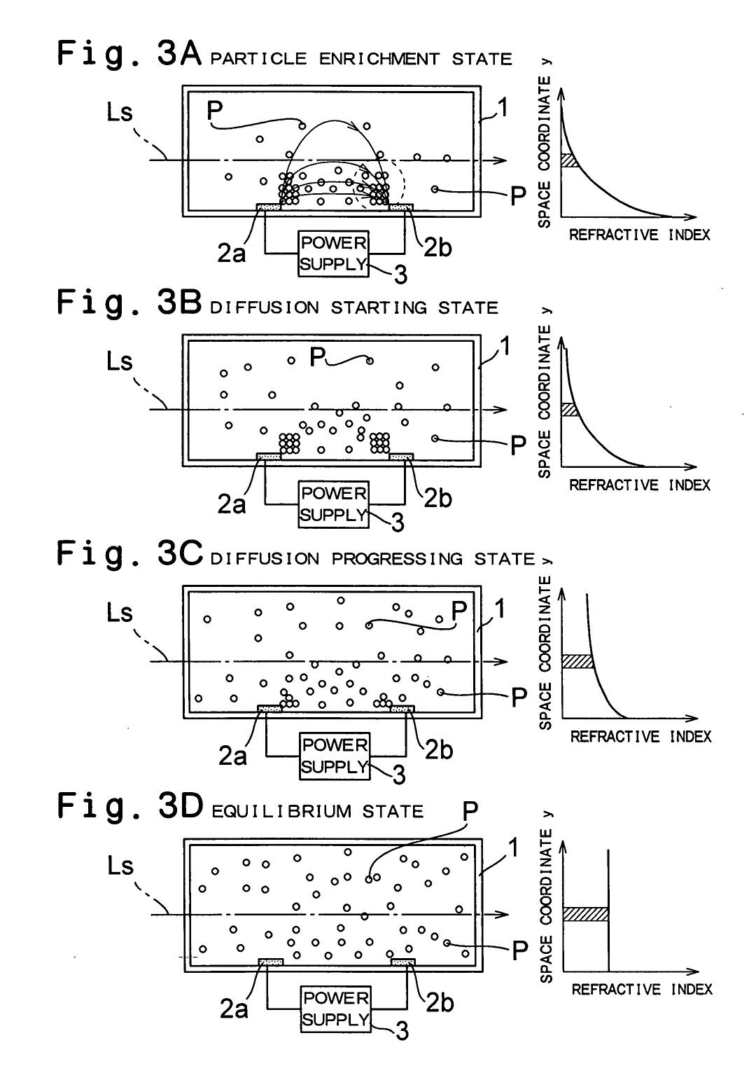

Next, the operation of the embodiment of the present invention having the above-mentioned structure will be described. FIGS. 3A to 3D are views for explaining the operation of the embodiment of the present invention. More specifically, FIGS. 3A to 3D each are a view, partly in a schematic view illustrating the behavior of the particles within the container 1 after the measurement operation starts and partly in a graph illustrating the modulation of the refractive index in a vertical direction within the container 1. In FIGS. 3A to 3D, a reference symbol P represents a particle to be measured.

In measurement, when an AC voltage is impressed upon the electrode pair 2 in a state when the sample in which the particles to be measured P••P are dispersed within the medium has been contained within the container 1, as shown in FIG. 3A, an AC electric field is formed within the container 1 and thus a dielectrophoretic force is applied to the particles to be measured P••P such that the particles to be measured are concentrated in the vicinity of the electrode pair 2. In a state in which the particles P••P is concentrated in the vicinity of the electrode pair 2, as shown in FIG. 3B, when the impression of the voltage upon the electrode pair 2 stops, the particles P••P starts to be diffused. After the voltage impression stops, as time goes on, the diffusion of particles P••P progresses as shown in FIG. 3C, and the particles finally returns to an original equilibrium state as shown in FIG. 3D.

In the meanwhile, the vertical modulation of the concentration of the particles P within the container 1 becomes a high state as the position of the particles P become closer to the electrode pair 2, accordingly, the position of the particles P become closer to the bottom surface 1a. When the refractive index of the medium is different from the refractive index of the particles P, as the graphs shown in FIGS. 3A to 3D, a spatial modulation substantially proportional to the concentration modulation of the particles P occurs in the refractive index of the sample that is a mixture of the particles and the medium.

A refractive index in the path of the sample light beam Ls positioned apart from the bottom surface 1a, where the electrode pair 2 is formed, of the container 1 by the predetermined distance varies according the progressing of the measurement operation as shown by shaded portions in the graphs.

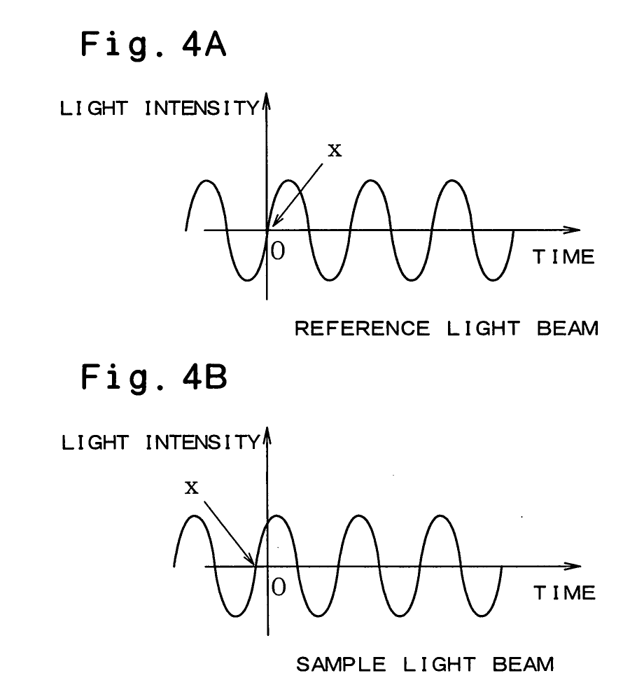

As described above, the phase of the sample light beam Ls is consistent with the phase of the reference light beam Lr until the sample light beam Ls is emitted to the container 1. When the sample light beam Ls passes through the sample, the phase lead or lag with respect to the reference light beam Lr occurs in the sample light beam Ls as shown in FIG. 4. Therefore, the beat signal generated by superimposing the sample light beam Ls and the reference light beam Lr is perceived as a detection signal of the refractive index of the sample by the detector 5 based on the optical heterodyning technique. In FIG. 4, there is shown an example in which, at a time point x, the phase of the sample light beam Ls is lagged with respect to the reference light beam Ls.

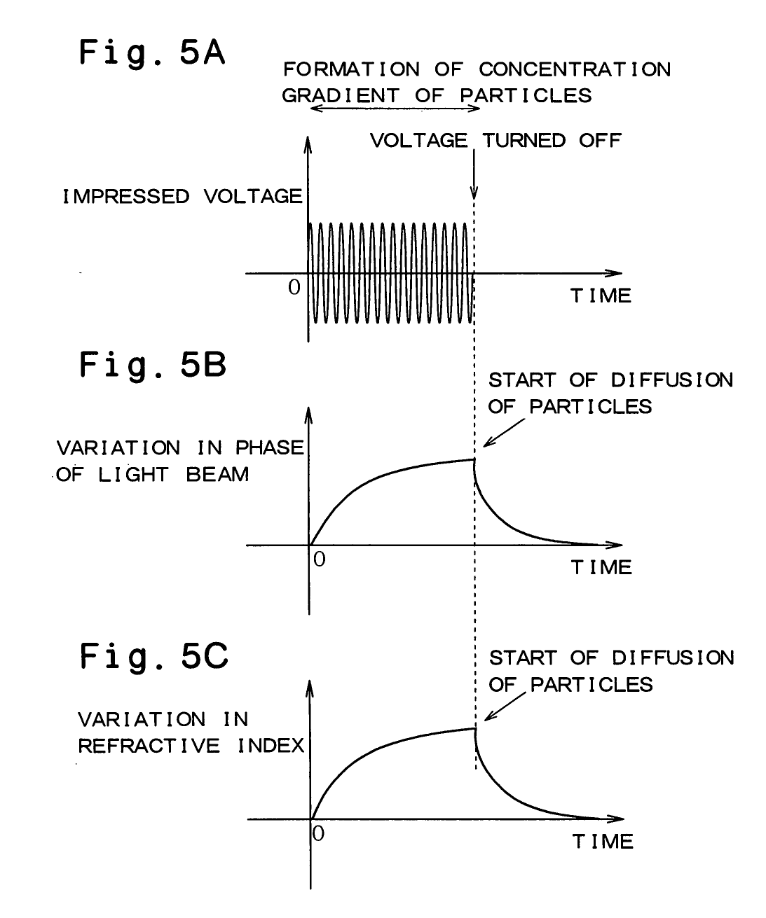

FIG. 5 is a graph showing graphs for explaining the above-mentioned measurement operation. More specifically, (A) of FIG. 5 shows the waveform of the voltage impressed upon the electrode pair, (B) of FIG. 5 shows a variation in the phase of the sample light beam Ls, and (C) of FIG. 5 shows a variation of the refractive index of the sample.

The result obtained by detecting the refractive index of a portion of the sample which the sample light beam Ls passes through every moment represents a temporal variation in the concentration of the particles P••P in the corresponding portion of the sample. A temporal variation in the concentration of the particles P••P after the voltage impression stops is expressed by the following diffusion equation (1).
∂u(y,t)/∂t=div[Dglad{u(y,t)}]. . . (1)

Here, u(y,t) denotes a particle concentration, y denotes a space coordinate in direction away from the electrode pair 2, and t denotes time. Also, D denotes a diffusion coefficients.

The diffusion coefficients D is expressed by Einstein-Stokes equation (2).
D=kT/(3πηd) . . . (2)

Here, k denotes Boltzmann's constant, T denotes an absolute temperature (K), η denotes the viscosity coefficients of the medium, and d denotes the diameters of the particles. When the particle concentrate is excessively high, the Einstein-Stokes equation is not satisfied. However, in this embodiment, the sample light beam Ls passes through a position which is apart from the electrode pair 2 by the predetermined distance has parted above direction and where the particles are trapped at high concentration immediately after the voltage is impressed upon the electrode pair 2, whereby the Einstein-Stokes equation is satisfied immediately after the stopping of the voltage impression.

Therefore, it is possible to obtain the particle diameters d of the particles to be measured by measuring a temporal variation ∂u(y,t) in the particle concentration at the position which the sample light beam Ls passes through.

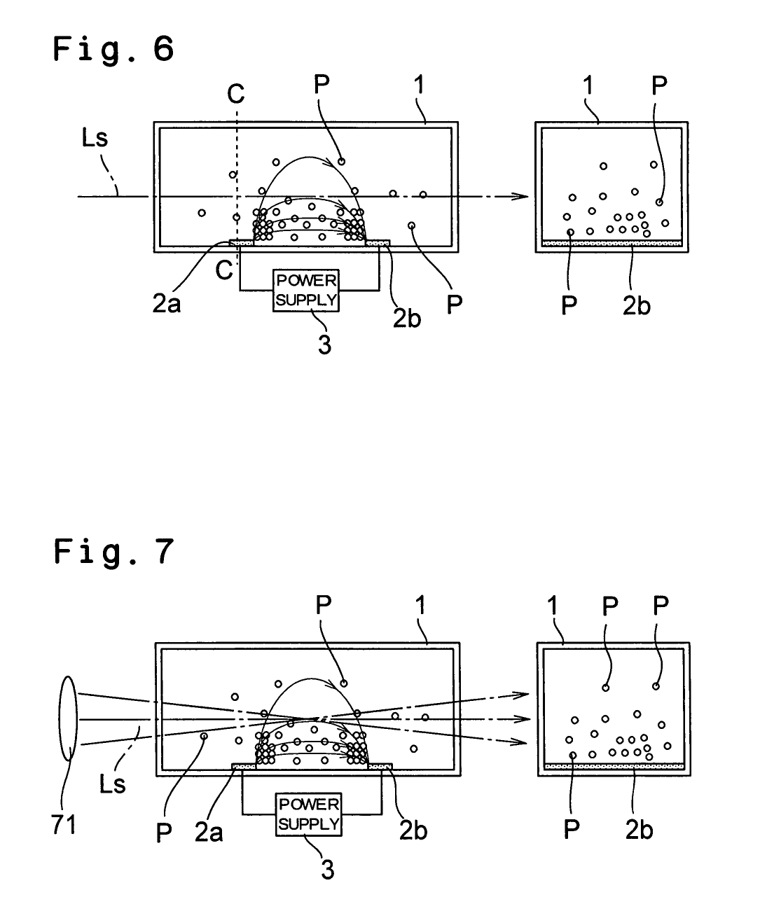

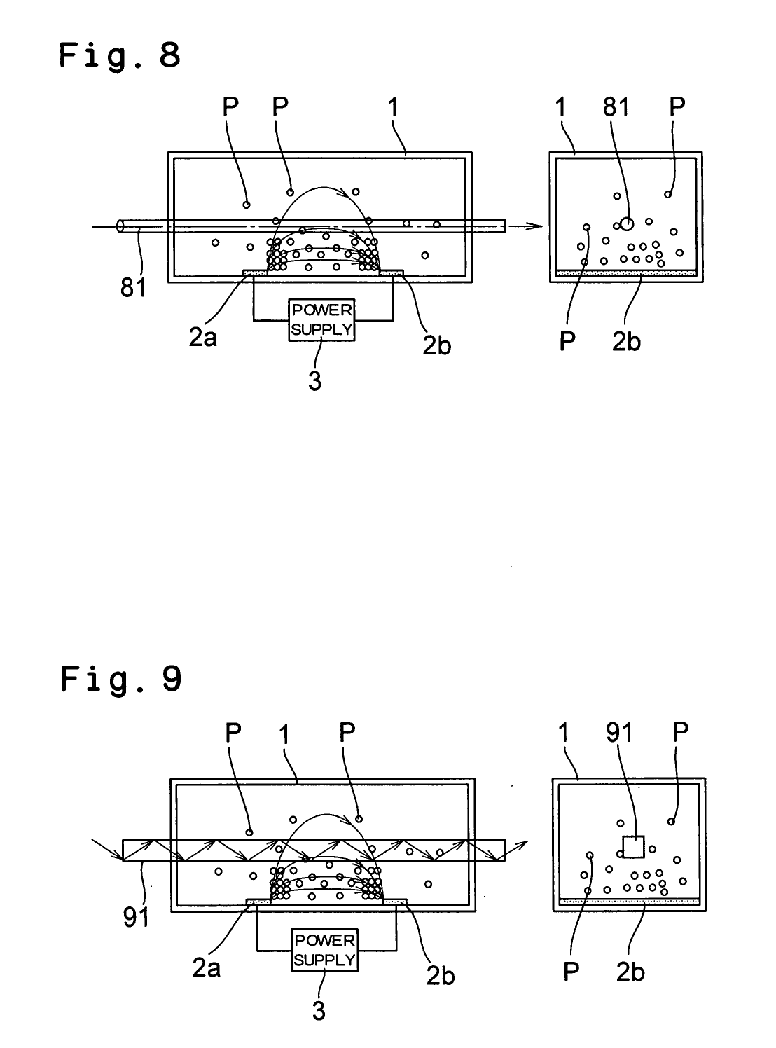

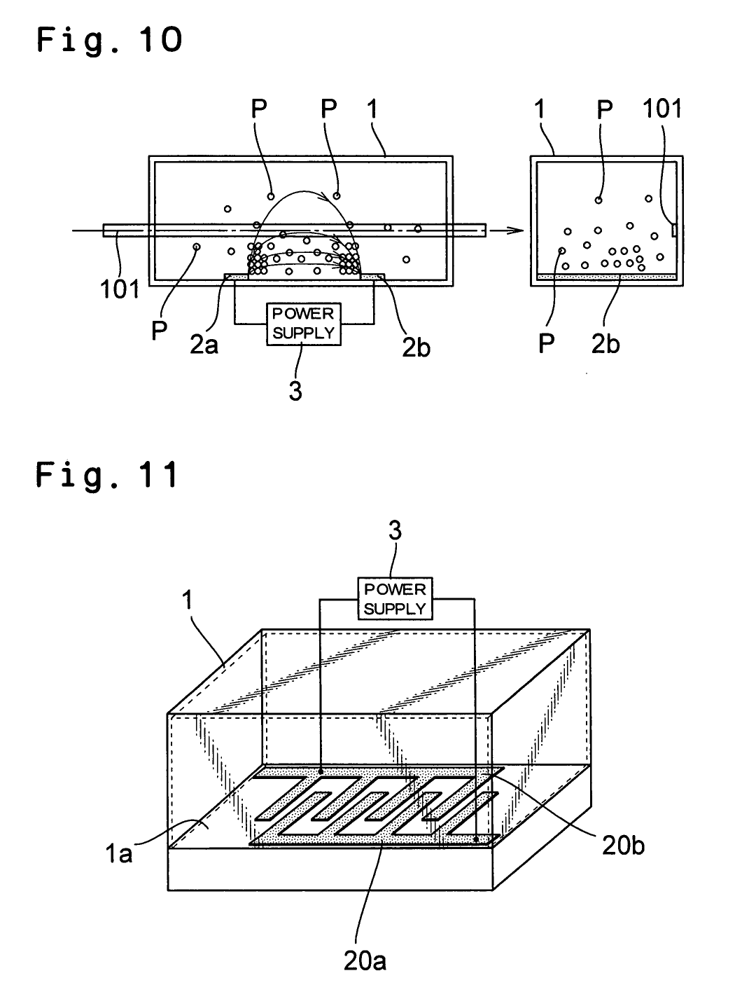

The above-described sample light beam Ls may pass through the container 1 as a parallel light beam as shown in FIG. 6 or it may be condensed by a lens 71 and pass through the container 1 as shown in FIG. 7. Also, the sample light beam Ls may be introduced into the container 1 through an optical fiber 81 as shown in FIG. 8. In this case, as usual practice of the measurement using the optical fiber 81, a portion of a clad layer of the optical fiber 81 is properly cut such that the light beam leaks out of the optical fiber 81. Further, it is possible to guide the sample light beam Ls into the container 1 by using an optical element 91 that transmits the light beam by total reflection, as shown in FIG. 9. Furthermore, it is possible to introduce the sample light beam Ls into the container 1 through an optical waveguide 101 fixed to an inside wall surface of the container 1, as shown FIG. 10.

The pattern of the electrode pair 2 for impressing voltage is made of the two electrodes 2a and 2b in the above-mentioned embodiment. However, the pattern of electrode pair 2 may be made of two comb-shaped electrodes 20a and 20b each having a plurality of electrode fingers as shown in FIG. 11.

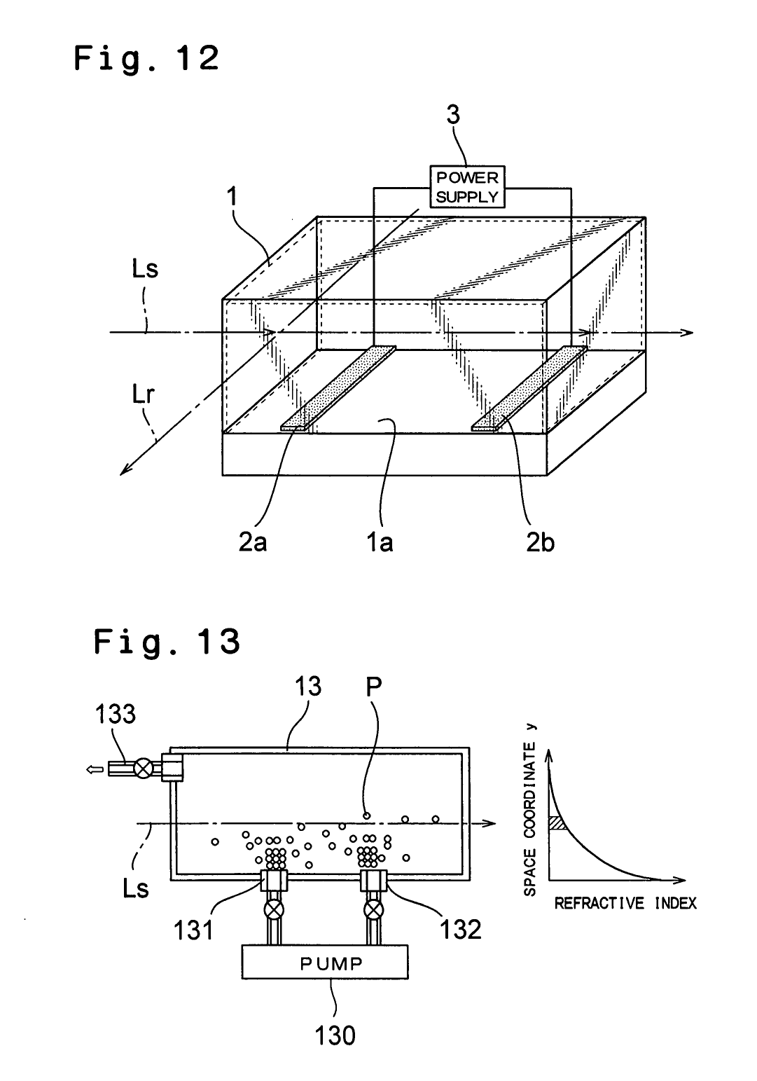

The sample light beam Ls and the reference light beam Lr are not always required to be parallel with each other. The reference light beam Lr may pass through the outside of the container 1 as in the above-mentioned embodiment or may passes a position where the reference light beam is not affected by a concentration gradient of the particles within the container 1, as shown in FIG. 12.

In the above-mentioned embodiment, there has been described an example in which, when the AC voltage is impressed upon the electrode pair 2, the particles is trapped by dielectrophoresis of the particles. However, in measurement of charged particles, it is possible to impress a DC voltage upon the electrode pair 2 so as to trapping the particles using the electrophoresis of the particles.

In the above description, a case of using a positive phoretic force to trap the particles by an attractive force has been described. However, it is possible to use a negative phoretic force having a repulsive force. In this case, when the voltage is impressed, the particles are kept away from the electrode pair 2, and accordingly, an area having a low particle concentration is formed in the vicinity of the electrode pair 2. Even in this case, for example, when the sample light beam Ls passes through the vicinity of the center of the container as in the above-mentioned embodiment, any particular problem does not occur and similar measurement as in the above-mentioned case of using the positive phoretic force may be performed.

In order to form the concentration gradient of the particles, it may be possible to use the phoretic force caused by the impression of the voltage upon the electrodes. Also, a pump may be used to form the concentration gradient of the particles. That is, as shown in FIG. 13, the container 1 is connected to discharge openings 131 and 132 of a pump 130 and a discharge opening 133 for discharging the sample out the container 1 is formed in the container 1. Then, in a state in which only a medium or a sample in which a particles to be measured is dispersed in low concentration within the medium is contained within the container 1, a sample in which the particles to be measured is dispersed at high concentration within the medium is guided into the container 1 by means of the pump 130. As a result, during the driving of the pump 130, areas, each having a high particle density, are formed in the vicinities of the discharge openings 131 and 132. Then, when the driving of the pump 130 stops, the particles start to be diffused and behave similarly as in the above-mentioned embodiment. Therefore, it is possible to obtain the diffusion coefficients and accordingly to calculate the particle diameters.

In order to detect a temporal variation in the particles, the refractive index may be detected by the optical heterodyning method as described above. In measurement of light absorbing particles, an amount of light beam absorbed by the sample is detected every moment by using a continuous light beam as the sample light beam, thereby capable of measuring a variation in the concentration every moment. Also, a method of measuring an amplitude variation, that is, a temporal variation in optical density by using two modulated light beams also can be used to measure a variation in the concentration every time. This invention also includes those methods.

1. A particle diameters measuring method comprising:
forming a concentration gradient of particles to be measured by impressing an electric field upon a sample in which the particles are movably dispersed within a medium through an electrode pair provided to be in contact with or close to the sample;
detecting a refractive index at a portion where the concentration gradient is formed by introducing a light beam to a portion where the concentration gradient is formed and which is apart from the electrode pair by a predetermined distance;
obtaining a diffusion coefficients of the particles within the medium from a temporal variation in the refractive index after the impression of the electric field upon the particles stops or changes; and
calculating the particle diameters of the particles by impressing the diffusion coefficients to Einstein-Stokes equation.

2. A particle diameters measuring device comprising:
a container containing a sample in which a particles to be measured is movably dispersed within a medium;
an electrode pair provided within the container to be in contact with or close to the sample;
a electric power supply impressing a positive or negative voltage upon the electrode pair;
a light source emitting a light beam to be introduced into a portion where a concentration gradient of the particles are formed by impressing the positive or negative voltage upon the electrode pair and which is apart from the electrode pair by a predetermined distance;
a refractive index detecting unit detecting a refractive index of the sample by using the introduced light beam; and
a calculating unit receiving an output of the refractive index detecting unit, obtaining a diffusion coefficients of the particles within the medium from a temporal variation in the refractive index after the impression of the voltage upon the electrode pair stops or changes, and calculating the particle diameters of the particles by using Einstein-Stokes equation.

3. The particle diameters measuring device according to claim 2,
wherein the refractive index detecting unit is based on an optical heterodyning technique using a sample light beam introduce from the light source to the portion where the concentration gradient of the particles within the container and a reference light beam generated from the light source passing through a position where the reference light beam is not affected by the concentration gradient.

4. The particle diameters measuring device according to claim 2,
wherein the parallel light beams are emitted to a portion of the container where the concentration gradient of the particles to be measured are formed.

5. The particle diameters measuring device according to claim 2,
wherein the light beam from the light source is condensed by a condensing lens to be introduced into the portion where the concentration gradient of the particles to be measured within the container is formed.

6. The particle diameters measuring device according to claim 2,
wherein the light beam is introduced into the portion, where the concentration gradient of the particles to be measured within the container is formed, through an optical fiber disposed within the container.

7. The particle diameters measuring device according to claim 2,
wherein the light beam is introduces into the portion, where the concentration gradient of the particles to be measured within the container is formed, through a total reflecting element that is made of a glass plate within the container.

8. The particle diameters measuring device according to claim 2,
wherein the light beam is introduced into the portion, where the concentration gradient of the particles to be measured within the container is formed, through an optical waveguide provided within the container.

9. The particle diameters measuring device according to any one of claims 2-7 and 11-13,
wherein a plurality of electrode pairs are formed within the container.

10. A particle diameters measuring device comprising:
a container containing a sample in which a particles to be measured is movably dispersed within a medium, or only the medium;
a pump injecting, to the container, a high concentration sample in which a particles to be measured are movably dispersed at higher concentration within a medium;
a light source emitting a light beam to be introduced to a portion where a concentration gradient of the particles is formed by injecting the high concentration sample;
a refractive index detecting unit detecting a refractive index of the medium in which the particles to be measured are dispersed by using the introduced light beam; and
a calculating unit receiving an output of the refractive index detecting unit, obtaining a diffusion coefficients of the particles to be measured within the medium from a temporal variation in the refractive index after the impression of the voltage upon the electrode pair stops or changes, and calculating the particle diameters of particles by applying Einstein-Stokes equation.

11. The particle diameters measuring device according to claim 3,
wherein the light beam from the light source is condensed by a condensing lens to be introduced into the portion where the concentration gradient of the particles to be measured within the container is formed.

12. The particle diameters measuring device according to claim 3,
wherein the light beam is introduced into the portion, where the concentration gradient of the particles to be measured within the container is formed, through an optical fiber disposed within the container.

13. The particle diameters measuring device according to claim 3,
wherein the light beam is introduces into the portion, where the concentration gradient of the particles to be measured within the container is formed, through a total reflecting element that is made of a glass plate within the container.

14. The particle diameters measuring device according to claim 3,
wherein the light beam is introduced into the portion, where the concentration gradient of the particles to be measured within the container is formed, through an optical waveguide provided within the container.
